(19) United States
(12) Patent Application Publication
(10) Pub. No.: US 2010/0287011 A1
(43) Pub. Date: Nov. 11, 2010

(54) Method and System of Location-Based Game for Improving Mobile Operator's Profit

(75) Inventor: Artem Muchkaev, Glen Waverly (AU)

Correspondence Address: Hogan Lovells US LLP, 1999 AVENUE OF THE STARS, SUITE 1400, LOS ANGELES, CA, 90067, US

(73) Assignee: Martec Corporation, Las Vegas, NV (US)

(21) Appl. No.: 11/939,450

(22) Filed: Nov. 13, 2007

(51) Int. Cl. G06Q 10/00; H04W 64/00; G06Q 30/00; G06F 17/00; G06N 5/02

(52) U.S. Cl. 705/7; 455/456.3; 705/14.12; 463/29; 706/45

(57) ABSTRACT

This invention provides a method for telecommunication carriers to generate revenues from location-based services (LBS) through a location-based game (LBG). Also provided is a method for administrating a location-based game and mobile terminals configured with LBG of the present invention. Games of the present invention may be played in stationary mode, mobile mode, or any combinations thereof; they may also include a scoring system that is based on token collection and, therefore, does not require real-time update or fast response from the LBS.

### FIELD OF THE INVENTION

The present invention relates generally to methods of generating revenue for telecommunication carriers. It also relates to a method of administering a location-based game and mobile terminals configured therewith.

### BACKGROUND OF THE INVENTION

Location-based services (LBS) or LoCation Services (LCS) are services that exploit knowledge about where a user of an information device is located. For example, the user of wireless-connected smartphone could be shown ads specific to the region the user is traveling in. The ability to provide such customized services represent the continuing trend of personalization in the consumer electronics market.

However, despite the obvious technological achievements, LBS has still yet to find a matching business model for wide adoption. Although most industry analysts believe that the market for LBS exists, recent findings from the leading market research firm In-Stat/MDR (www.instat.com) reveals that it is not the “killer-app” the industry once believed it to be. Based on current available data and the business environment, In-Stat concluded that it is highly unlikely the carriers will break-even on their investments for at least another decade. Even though the total addressable market (i.e. number of existing wireless subscribers) for offering LBS is large, the actual potential of that market will be quite small.

In a recent industry gathering in Munich where numerous presentations were given by telecommunication carriers from around the world, In-Stat's assessment was readily confirmed as most carriers reported unfavorable revenue generating prospect for LBS. Despite the fact that practically every American wireless subscriber will soon be able to receive highly accurate location information on their mobile phones thanks to the E911 mandate issued by the Federal Communication Commission (FCC), no clear strategy has been identified to recover the cost to carriers, which has been estimated to be in the billions of dollars. Faced with this unfunded government mandate, the carriers have experimented with different business models to meet the mandate without imposing undue financial burden on themselves. In one conventional business model, it is envisioned that LBS would be a valuable service to large organizations that may benefit from real-time geographic information for resource allocation purposes. For example, taxi fleets, trucking companies, the military, and police have obvious needs for such services. However, while the need for these specialized services is great, commercial carriers are usually not the ideal service providers because of security and reliability considerations. In particular, military and government agencies typically will favor building their own proprietary system instead of sharing the service with consumers. Therefore, despite the great market size and demand in this sector, the potential for commercial carriers to capture this market segment is very limited.

Beyond specialized applications, advertising has traditionally been the major source of revenue for communication channel providers such as TV, radios, and, more recently, internet websites. In the case of LBS, pushing advertisement to mobile device users based on their location would have been a natural business model for providing substantial revenue streams to the carriers. Unfortunately, with the passing of the CAN-SPAM Act in 2005, it has now become illegal in the United States to send any messages to the end users without the end users specifically opting-in. This regulatory constrain has significantly reduced the earning potential of LBS for the carriers as far as carrier-centric business models are concerned. As a result, there has been a shift in focus to pursue user-centric business models for LBS (i.e. services that give the user control of the experience, typically by opting in first via websites or mobile interfaces such as SMS, mobile Web, and Java/BREW applications).

For the carriers, a successful LBS business model should have potential to improve average revenue per user (ARPU) across some portion of the existing customers, attract new subscribers and penetrate new markets. LBS should be integrated into many of the carrier's existing applications and service offerings and enable a value-added location component to current services. To date, no existing LBS business model is capable of satisfying all of these criteria. A few exemplary user-centric business models that have been considered to date will be discussed here to illustrate the difficulties the carriers currently face.

In one scenario, the proverbial Yellow Book service has been considered. In this type of business models, the LBS is a location-based Yellow Book service for providing information such as restaurants and services nearby the end user's current location. Users will either pay a subscription fee or pay on a per use basis. However, the revenue growth potential of this type of business models is also limited because consumer habits are such that most people shop and dine at familiar places and the need for such ad hoc information is infrequent at best. In light of the inherent limitations of consumer behavior, these types of business models are not likely to provide constant sources of recurring revenues. Moreover, internet websites such as Google and yahoo already provide similar free services through their websites and can be accessed through web browsers on mobile devices without LBS. Therefore, in addition to having limiting revenue potential, this type of business models also face an extremely unfavorable competitive landscape.

In another example, a home zone/office zone tiered service model has also been considered. Tiered pricing is a commonly used marketing method in many industries. This type of business model seeks to segment the market according to different level of consumer demand and price elasticity (i.e. the effect of pricing on consumers' willingness to buy). It is thought that by pricing the services differently depending on whether a subscriber is using the service at home or in the office, a larger proportion of price-sensitive consumers can be captured. In economic terms, the total revenue of a company can be increased this way because tiered pricing increases the total market size captured by the company. However, despite the success of tiered pricing in other markets, this type of business models are not likely to work for LBS because current market penetration level of mobile subscribers are already very high and prices for existing service plans are low enough that tiered pricing will only see a marginal effect on usage increase. Moreover, in this type of business models, LBS is treated as an account administrative infrastructure for the carriers, therefore, the cost of deploying LBS may not be easily passed on to the subscribers.

Other business models such as emergency locator and navigation assistant all suffer from similar problems of limited market size and significant competitive pressure. Therefore, there is still a need for more innovative business models that can improve the financial outlooks of LBS related technologies.

### SUMMARY OF THE INVENTION

Accordingly, it is one object of the present invention to provide a new LBS business model for telecommunication carriers to generate revenue from LBS-related technologies.

It is also an object of the present invention to provide methods and systems for implementing the business models of the present invention.

These and other objects of the present invention are achieved in a business method for generating a revenue from location-based telecommunication services, having the general steps of: (1) providing a telecommunication infrastructure offering telecommunication services, including location-based services; (2) providing a location-based game capable of utilizing all telecommunication services provided by the telecommunication infrastructure, including location-based services, wherein the game supports a stationary mode, mobile mode, and combinations thereof; and (3) accounting for usage of the location-based services by at least one player during game play, wherein the game is designed such that usage of location-based service provides game winning advantages to the players, thereby encouraging the usage of the service.

In another aspect, the present invention also provides a method of administering a location-based game hosted on a game server over a telecommunication network, having the general steps of: (1) creating a virtual space having a plurality of zones within the game, wherein the plurality of zones are mapped to regions of physical space covered by the telecommunication network; (2) allowing players to join the game by establishing communication with the game server via the telecommunication network, wherein upon joining, each player is assigned a token; (3) providing the players with information of game environments upon request by the players, wherein the game environment for each player is determined by the physical location of the player, and wherein said request by the players is performed by utilizing location-based services provided on the telecommunication network; (4) allowing the players to choose a virtual zone to explore, wherein the act of exploring includes scanning for other players currently residing in the chosen zone; and (5) allowing the players residing within the chosen zone to interact with each other in a competitive contest, wherein upon winning the contest, the winning player receives the token(s) of the losing player, wherein the game is completed when a player or a team of players accumulates a predetermined number of tokens to win the game.

In yet another aspect, the present invention also provides a mobile terminal configured with a location-based game administered according to the above mentioned method of game administration.

In still another aspect, the present invention also provides a process for designing location-based games suitable for deployment on a telecommunication infrastructure offering telecommunication services including location-based services, having the general steps of: performing a value-chain analysis to build a value-chain model that describes a value creation process having a plurality of value creation activities, wherein the value-chain activities encompasses activities from both the game industry and the telecommunication industry; identifying a value creation activity of interest from the telecommunication industry; and creating a design for the game utilizing the value creation activity of interest in the game such that the value creation activity of interest is presented in the game as a feature that gives players of the game a winning advantage.

The above-mentioned and other features of this invention and the manner of obtaining them will become more apparent, and will be best understood by reference to the following description, taken in conjunction with the accompanying drawings. These drawings depict only a typical embodiment of the invention and do not therefore limit its scope. They serve to add specificity and detail.

### BRIEF DESCRIPTION OF THE DRAWINGS

FIG. 1 shows a block diagram of a conceptual framework of a business model according to one embodiment of the present invention.

FIG. 2 shows a block diagram model of a value chain in accordance with embodiments of the present invention.

FIG. 3 shows an exemplary infrastructure capable of supporting LBS.

FIG. 4 shows an exemplary LBG being hosted by a game server that communicates with mobile phones using the telecommunication carrier through Internet, wired, fiber-optic or wireless link. The game server can be included into the telecommunication infrastructure as well.

FIG. 5 shows an algorithm of an exemplary game logic in accordance with one embodiment of the present invention.

FIGS. 6-11 show illustrations of screenshots of an LBG in accordance with one embodiment of the present invention.

FIG. 12 is an illustration showing an exemplary selection of network protocols that maybe supported by an exemplary LBS capable carrier in accordance with embodiments of the present invention.

### DETAILED DESCRIPTION

The present invention set forth a novel business model in which novel location-based games are provided to form a business process that generates demand and revenue for location-based services. To facilitate a full and complete appreciation of the present invention, a general discussion of business models and the current state of location-based games will be provided first followed by a detailed description of the various aspects and embodiments of the present invention. Following conventional terminology in the art, the terms “carrier”, “telecommunication carrier”, and “telecommunication provider” will be used interchangeably to refer to the provider of a telecommunication infrastructure and its services.

### Business Models

The term “business model” has been used loosely in the business literature to refer to a broad range of informal and formal models that are used by enterprises to represent various aspects of a business, including operational processes, organizational structure, and financial forecasts. Despite the popular use of this term in discussions of business processes, systems, and strategies, no single definition of what comprises a business model has yet been agreed upon. In its most simple form, the concept of a business model can be intuitively understood as the problem that a business solves and the way by which the business solves it to make profit.

In the context of the present invention, we will take a systems approach (i.e.

viewing the business model as a system) to the discussion of business models. That is, for the purpose of the present invention, the term “business model” refers to a conceptual framework that describes four fundamental concerns of a business: (1) infrastructure (e.g. core capabilities, partner network, and value configuration), (2) offering (e.g. products, services, and value propositions), (3) customers (e.g. target customers, distribution channels, and customer relationship), and (4) finances (e.g. cost structure, and revenue). In short, a business model is a description of how a business sets up its infrastructure to provide products and services to customers of varying needs so that profit is generated.

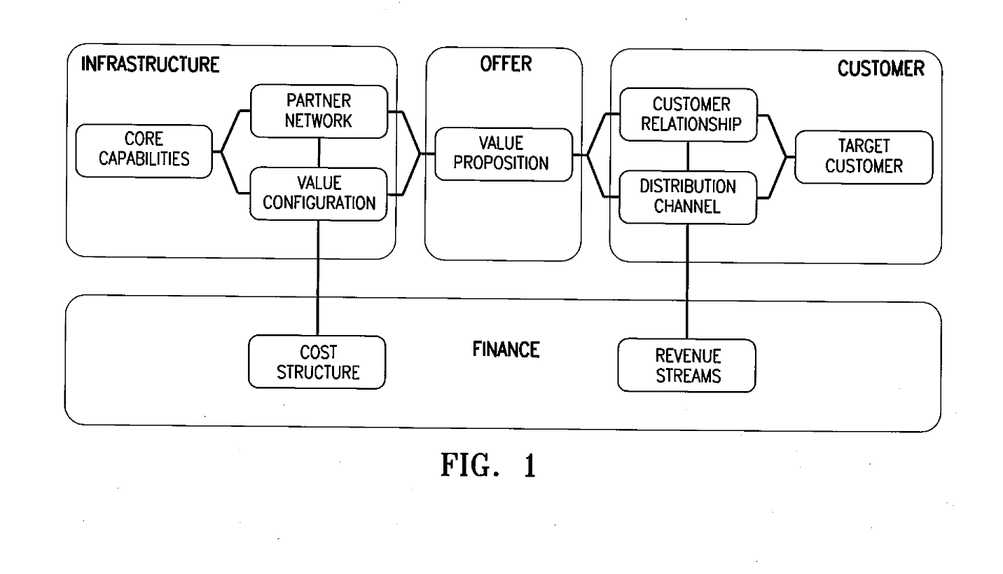

To further illustrate this concept, FIG. 1 shows a block diagram representation of the conceptual framework of a business model. This conceptual framework will be used in the following discussion to facilitate a better understanding of the various aspects of the present invention.

### Location-Based Games

Recently, the concept of incorporating location information of a player into a game play, herein referred to as “location-based gaming,” or LBG, has emerged as a new form of entertainment. There are currently a number of games that attempt to offer this new style of game play. However, none of the existing games has achieved mass appeal and most of them lack a coherent approach to revenue capture. In other words, the economics and overall business model had not been part of the game design process. Instead, the design process of current location-based games can be described as mostly focusing on the technical aspect of recasting old games on a new gaming platform (e.g., PAC-LAN—a LBG version of the famous arcade game PACMAN).

Rashid et al. has recently published a systematic review of existing and upcoming location-based games (ACM Computers in Entertainment, Vol. 4, No. 1, January 2006. Article 3C., the entire content of which in incorporated herein by reference). In the article, Rashid et al. points out five characteristics of existing game concepts that may be of concern to developers:
(i) current game designs all require player movement as a necessity;
(ii) games cannot simply be consumed; to entertain, they consistently need the players to act;
(iii) games often require other users to function;
(iv) current generation of location-based game concepts are not able to introduce a story; and
(v) location-based games have inherent limitations to handle player network latency in fast moving games.

However, these characteristics are also the hallmark of consol games. It is unclear how one may grow beyond these time-test principles of game design. Without unduly repeating the analysis of Rashid et al., existing games can be generally categorized into the following four major types:

Search and Destroy Combat Games: Examples of this type of games include Botfighter, which is generally regarded as the first location-based game, and Botfighter 2. Games of this genre place heavy demand on the location accuracy and response time of the system.

Treasure Hunt Games: Examples of this type of games include Mogi, and ConQwest. Games of this genre typically require players to physically move around in order to advance game play.

Adventure Games: The game The Journey II is one example of games in this genre. Games of this type attempts to inject storylines into game play. However, this type of games usually require significant attention and active participation of garners over a long period of time.

Educational Games: The game Frequency 1550 is one example of games in this genre. This type of games attempts to combine educational content with on-location game play. This type of games are limited to the educational market and also demand significant attention and participation from the game players.

As one can readily discern, these games all share the common characteristic that they all treat the mobile terminal as a constrained gaming consol. The implication of this approach to game design is that game developers fail to appreciate the difference between the underlying economics of the gaming platforms, and, therefore, is unable to design games that can maximize the revenue potential of the stake holders, particularly the telecommunication carriers.

For example, in the traditional consol gaming industry, the stake holders are the game developers, the publishers, and the consol makers. The interrelationship among these stake holders are semi-independent of each other. The consol makers get their revenue from sales of consol while game developers get their revenue from sales of the games. The publishers act as the middleman and also get their revenue from sales of the game. Under this paradigm, a game developer's main concern is to make games that publishers will buy. Although a consol maker holds certain degree of control over the developer, and a game developer may be persuaded to develop games that create specific economic benefits for a unique feature of a consol, the technology and competitive landscape is such that the economic success of consol makers and game developers are only loosely coupled at best. As often happen in the gaming industry, when a game sells well on one consol, it can always be adapted to work on a different consol, and vice versa. Therefore, there is no overriding imperative for the game developers and consol makers to act in each other's interest. Consequently, the stake holders in the gaming industry have not had to take a holistic approach to their business and each has been acting mostly on their own immediate interests.

In the emerging location-based gaming market, the telecommunication carriers may be viewed as a replacement for the consol makers. This market reality may explain why the location-based games developed so far all appear to be straight adaptations of consol games. Given the current mindset of game developers, the design of location-based games are necessarily constrained to the design principles of conventional consol games. It is an observation of the present invention that without a paradigm change, location-based games designed with the business model of consol games cannot adequately drive sales of telecommunication services.

By carefully considering the market structure of location-based games, the inventor of the present invention has devised a novel business model based on a value chain analysis of the combined telecommunication and gaming industry such that in a game designed in accordance with embodiments of the present invention, the interests of all stake holders are addressed in a cooperative framework. In particular, in a business process of the present invention, LBS is able to become a revenue generating profit center for the carrier. That is, in the business model of the present invention, game design is not treated as an independent activity, but an integral component of a business process that uses the game as a focal point to build consumer base and encourage consumption of all other services and products provided by the telecommunication carrier and its partners.

Accordingly, in one aspect, the present invention provides a business method for generating a revenue from location-based telecommunication services, comprising the steps of (1) providing a telecommunication infrastructure offering telecommunication services, including location-based services; (2) providing a location-based game capable of utilizing all telecommunication services provided by the telecommunication infrastructure, including location-based services, wherein the game supports a stationary mode, a mobile mode, and combinations thereof; and (3) accounting for usage of the location-based services by at least one player during game play, wherein the game is designed such that the usage of location-based service provides game winning advantage to the players, thereby encouraging the usage of the service.

To maximize the number of potential game players, it is preferred that the game allows both stationary mode and mobile mode playing. This is important because the majority of gamers will not be hardcore garners, but casual garners who are looking to be entertained as a way to pass time during waiting periods such as when stuck in a traffic jam, waiting in the doctor's office, waiting in grocery shopping line, etc. Games that require mobile mode (physical movement of the player) are not suitable for this purpose and, therefore, are unable to capture this large market segment.

It is also preferred that the game allows team collaboration so that garners will be encouraged to utilize all communication services such as voice, text messaging, etc. from within the game. Although at times, such as at the beginning of a game when few players have joined the game, artificial intelligence controlled players may be provided to keep game play interesting. As used herein, the term “artificial intelligence controlled player” refers to a game character not controlled by a human player, but by an artificial intelligence algorithm such as a search algorithm, a learning algorithm, or any other artificial intelligence algorithm commonly known in the art.

In one preferred embodiment, the game is designed such that it is not required to utilize location-based service to participate in game play, however, utilization of the location-based service will give the player a competitive advantage in winning the game. Utilizing the psychological principle of positive reinforcement, usage of location-based services will be encouraged. Preliminary data show that the game Botfighter claims a revenue of about 10 to 100 Euro per person (See Rashid et al., page 13). As previously explained, physical movement is mandatory for games such as Botfighter, thus, LBS revenue is generated only when a player has time to actively play the game. In contrast, when the game allows passive participation, for example, allowing users to use LBS to scan the game virtual space or otherwise gain certain competitive advantage, usage of LBS and the associated revenue may be greatly increased. Therefore, extrapolating from the revenue of Botfighter, one may expect revenues generated from games of the present invention to be substantially greater.

In another aspect, the present invention provides a location-based game. The game preferably has a design that conforms to a value chain model of the combined telecommunication and gaming industries. This objective is achieved by a LBG that is team-oriented; capable of consuming all services provided by the carrier; and does not require the players to change his or her geographical location in order to advance game play.

More specifically, a LBG in accordance with embodiments of the present invention will have one or more of the following characteristics:
(1) capable of being played both in stationary and mobile mode;
(2) capable of utilizing all communication services offered by the carrier;
(3) capable of allowing the player to choose any scalable zone in areas supported by the LBS (not only limited to the player's immediate geographic vicinity);
(4) providing a novel scoring system for determining scoring status such as points, bonuses, and forfeit;
(5) not requiring additional hardware and infrastructure beyond those already deployed in existing LBS system;
(6) being a software only implementation that is compatible with existing mobile devices;
(7) being platform independent with respect to LBS platforms; and
(8) capable of utilizing only standard equipment and specifications of the carrier's communication system.

Moreover, an LBG in accordance with the present invention may have at least the following advantages. First, because an LBG of the present invention does not require addition infrastructure upgrades, it will be cost-effective for carriers to deploy and administer. Second, because games in accordance with the present invention may be played in any combination of stationary and mobile modes, they would be able to accommodate a wide range of gaming situations and, thereby, would appeal to a diverse population of consumers with different gaming requirements. Last, because games in accordance with the present invention induces consumption of all services provided by the telecommunication carriers, some of which would not otherwise have been consumed, they provide additional revenues for the carriers.

Having generally described the characteristics and advantages of this invention, a further understanding of the invention may be obtained by reference to the specific embodiments described below and in the accompanying figures. Those skilled in the art will appreciate that these exemplary embodiments and figures are provided herein for purposes of illustration only and are not to be construed as limiting.

### Value Chain Analysis

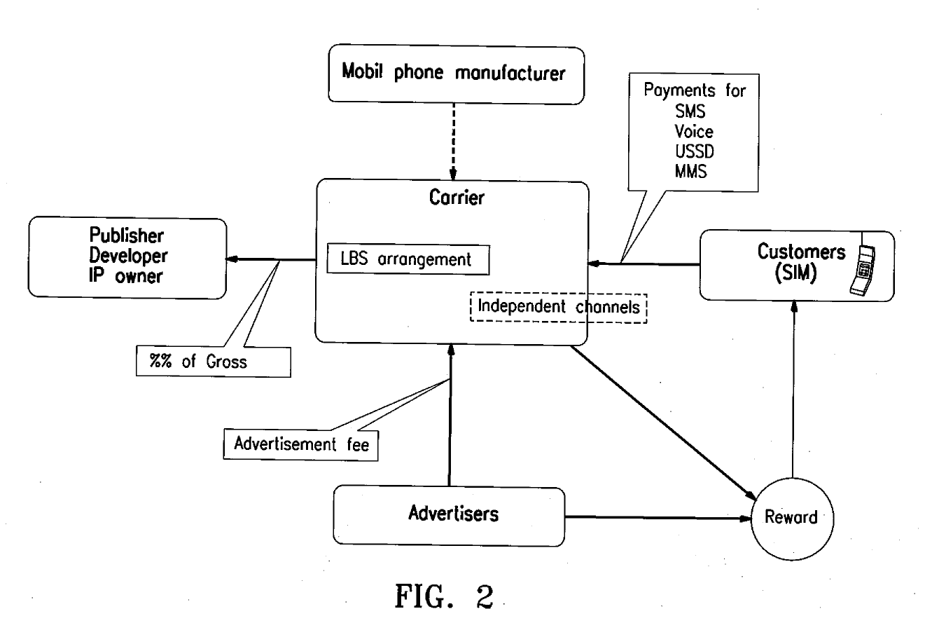

FIG. 2 shows a value chain analysis of the interrelationship between telecommunication carriers and game publishers. As shown in FIG. 2, participants in this value chain (i.e. game developer/publisher, mobile phone manufacturer, customers, advertisers, and carrier) are engaged in a range of interrelated business activities. In accordance with the present invention, the value creation process in a LBG-driven LBS business model can be thought of as starting from the creation of a game by the game developers and ending at consumption of the game by end users.

In the first stage of this value creation process, the game developers take a game concept from creation (e.g. brainstorming, story boarding, etc.), development (e.g. coding, testing, etc.), all the way through to the final playable release running on a wide variety of mobile devices. At this stage, the values created by the developers may include intellectual property and playable games encoded in executable software.

After the games are created and tested, the publishers may then bring the games to the market. At this stage, the values created by the publishers may include packaging, marketing, and deal making with potential partners. The publishers add value to the games by acting essentially as the marketer and promoter of the game.

In conjunction with game creation, mobile device manufacturers such as mobile phone handset makers may also participate in the value creation process by providing handsets and other mobile devices capable of running the games. This may involve designing and embedding proprietary API as well as including run-time environments for the game.

Finally, closing the loop, the carriers play a central role by providing an integrated platform for all participants to interact together in the process; they supply the mobile device manufactures and game publishers with a large customer base, drive pricing, LBS technology standards and specifications, enable various billing models, and operate the network infrastructure that connects all the pieces together.

In addition to the carriers, independent channels not owned by the carriers may also participate in the value chain by providing internet service, wireless application protocol (WAP) and short message services (SMS), as well as LBS services (e.g. location technology based on subscriber identify module (SIM)).

Each of the component steps described above represents a value creation activity for the respective participants. In the case of the customers or consumers, the value extracted is that of entertainment and potentially monetary reward provided by the game publisher or the carrier, depending on the specific embodiment of the game. In the case of mobile device manufacturer, interest in the game may stimulate sales of additional mobile devices, which, in turn, would increase revenues for the manufacturer. In the case of the telecommunication carriers, by providing the gaming platform for their subscribers to consume the LBG, additional revenues may be generated through gaming-specific usage of the carriers' services.

### LBG-Driven Business Model for LBS

### 1. LBS Infrastructure

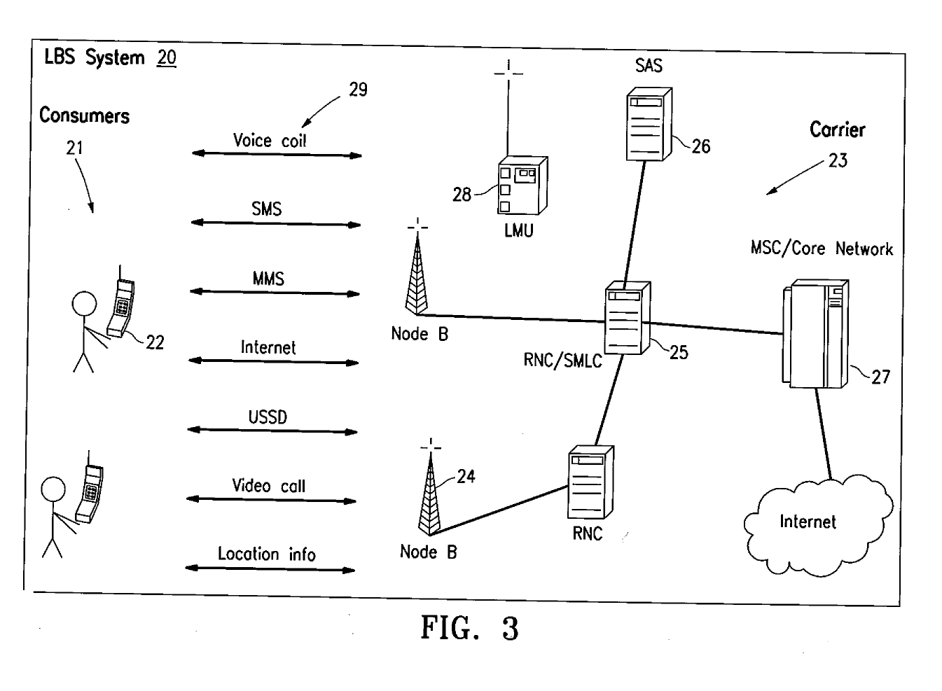

Referring to FIG. 3, there is shown an exemplary LBS infrastructure capable of providing location-based services and serving as a platform for implementing location-based games. A typical LBS system 20 generally has end users (consumers) 21 with mobile terminals 22 in wireless connection with the network carrier 23.

The mobile terminals 22 may be any mobile devices including any device capable of wireless connection with the network carrier 23 such as mobile phones, PDA, and laptop computers, but not limited thereto.

The network carrier 23 may include a plurality of signal broadcast nodes 24 connected to radio network controllers (RNC) or Serving Mobile Location Center (SMLC) 25, and Standalone Assisted-GPS SMLC (SAS) 26. The wireless network may be connected to the internet through a mobile switching center (MSC) 27. The network may further comprise a location measurement unit (LMU) 28 for determining the distance of mobile stations (MS). The end users 21 may communicate through the network using mobile devices 22 in any number or combinations of communication protocols 29 supported by the network. For example, end users may exchange location information as well as place voice calls, send short messages through SMS protocol, exchange multimedia files via MMS protocol, and surf the web through TCP/IP.

As telecommunication technologies improve, new communication protocols and devices may also be included.

### 2. Offerings

In a business model of the present invention, what is offered to the consumers is a location-based game. In general, location-based games describe any game that incorporates the player's location (including player's relative location) and/or movement. This may include tracking a phone as it moves or monitoring player's direction, velocity and acceleration during the game playing. Location-based games could be multiplayer game where teams or other groups commune for the purpose of playing the game or sharing some game related experience. Location identification and multiplayer capability together with other technologies such as 3D graphics, camera technology, and joystick input makes the mobile phone a device with huge creative potential for new gaming experience. All of these advances are great for the telecommunication carriers as data traffic is small, but regular and tends to generate high profit margin.

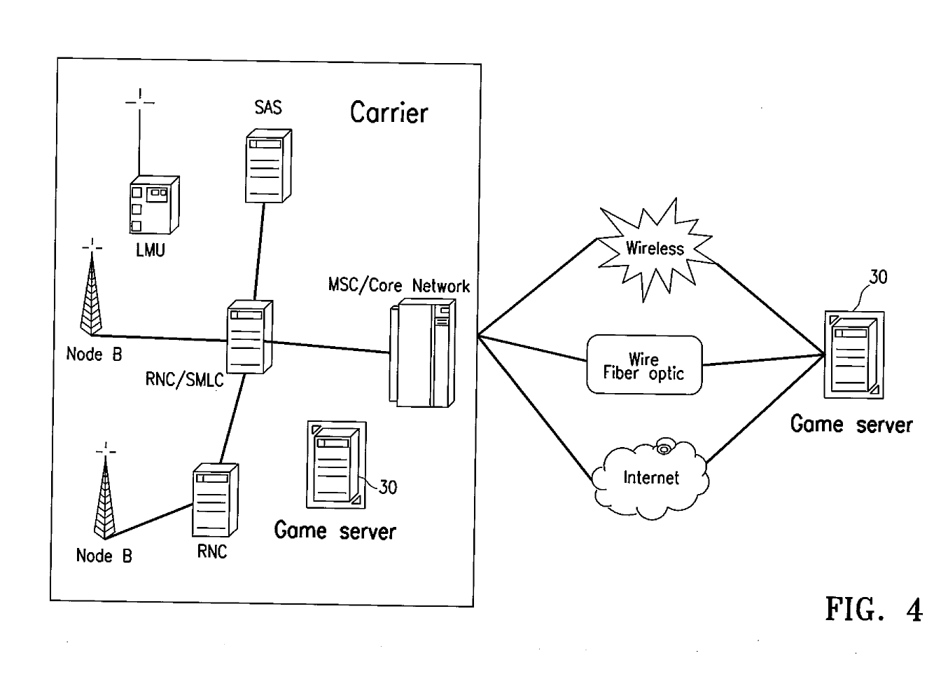

Referring to FIG. 4, an exemplary location-based game of the present invention may be hosted by a game server 30 that communicates with mobile terminals 22 using the carrier through connecting media such as the internet, wire fiber optics, or wireless links. The game server 30 can be included into the carrier system as well.

In order for an end user 21 to join the game, the end user 21 can download a software module into the mobile device 22 from the game server 30 or game website. Alternatively, the game can be pre-installed on mobile terminals 22.

In one embodiment, the basic game concept of the LBG according to the present invention is simple and has a low learning curve. A storyline may or may not be included. For example, the game may be a simple contest game with a few simple rules but no storyline. Alternatively, the game may have a story backdrop in which players may take roles. When the game includes a storyline, the storyline can be different in different embodiments, but the game concept remains the same.

To illustrate the basic game concept, one embodiment is described herein. In this illustrative embodiment, the game has a storyline in which two teams battle each other to capture the other team's hidden flag. When a player joins the game he becomes a member of one of the two teams and gets a token which may be a code word, a password, or an encrypted information packet encoding clues to the team's hidden flag. In one embodiment, the player does not know the token and the token is processed behind the scene and assigned to the player by the game system. Each team has its flag at the secret location designated in the game system. The game mission of the team is to find the other team's flag (location) while determining the pathway starting at the game start point and ending at the flag location. The pathways of antagonistic teams is shown at the game website/mobile phone. In order to build the pathway the first team's player locates and fights the other team's player and vise versa. When a target is defeated, the player gets the target's token, earns new abilities, and earns points on the high score list after sending a predetermined number of obtained tokens to the system.

Using the mobile terminal, the player can scan a surrounding territory to find friends and enemies located at close distances to him. The scanner allows a plurality of levels of scanning: for example, within a circle zone of 200, 300, or 400 meters radius from the player. When the first team's player (“a first player”) finds the other team's player(s) (“a second player”) within the zone, the first player can challenge the second player to fight in several alternative ways as provided by the game. For example, the challenge can be a fighting game, a shooting game, a game of chance, or a game of wits. In addition, initially each player can have single use bonus to scan remotely the zone located at any place on the map. The player can get additional bonuses if he sends a predetermined number of captured codes to the system.

As the tokens become available in the system, the pathway required begins to emerge at the website allowing monitoring the team achievements in several different ways depending on the storyline of a particular game. When all or almost all tokens have been gathered by a team, it means that the pathway is determined and the enemy's flag is localized. The player(s) who is at the top of high score list can be rewarded.

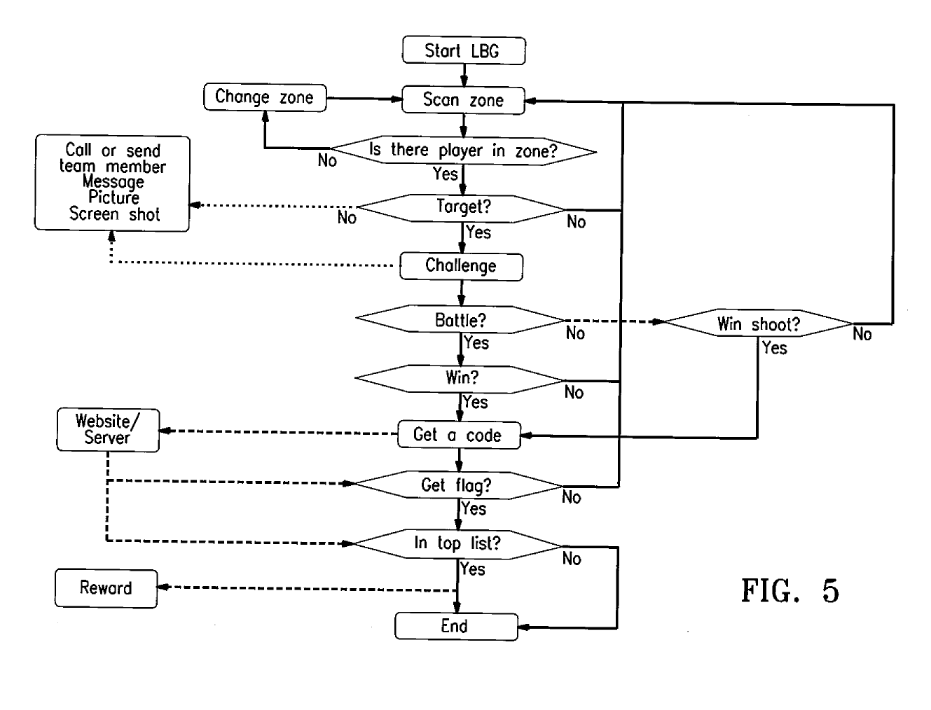

FIG. 5 shows an algorithm summarizing the basic game logic as described above. A game utilizing this gaming logic is ideally suited to a LBG-driven business model as previously discussed. The ability to allow players to join the game at any time means that no special arrangement is required to organize a game. A player can even join multiple on-going games to maximize his/her chance of winning a game reward. The use of a token (e.g. code words or information packets) as a way to keep score of game progress obviates the need for the game to be in constant contact with the game server, thereby reducing network communication requirement, making it possible for a large number of players to participate in a game without causing system latency issues.

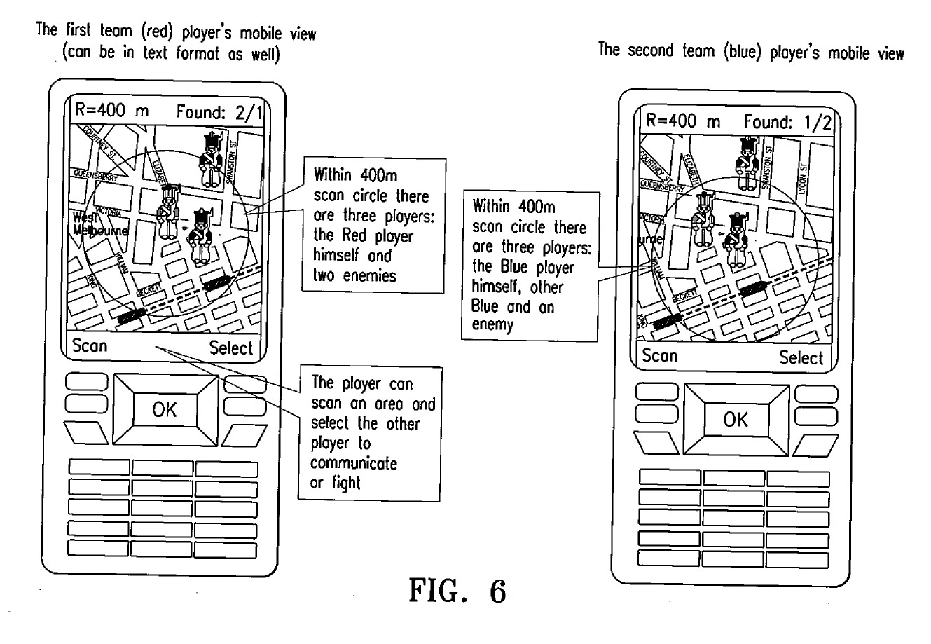

FIG. 6 shows an exemplary implementation of the flag battle game as described above. As shown in the Figure, a player joining the game sees a map representation of the game environment near the player's current location. Members of the two teams (designated Red team and Blue team) will have a different view of the game environment corresponding to the situation of their respective game characters. For example, the left hand side figure shows a view for a Red team member (soldier with gray uniform) who initiated a 400 m radius scan for enemies and foes. The right hand side figure shows the respective view for a Blue team member (solder with black uniform).

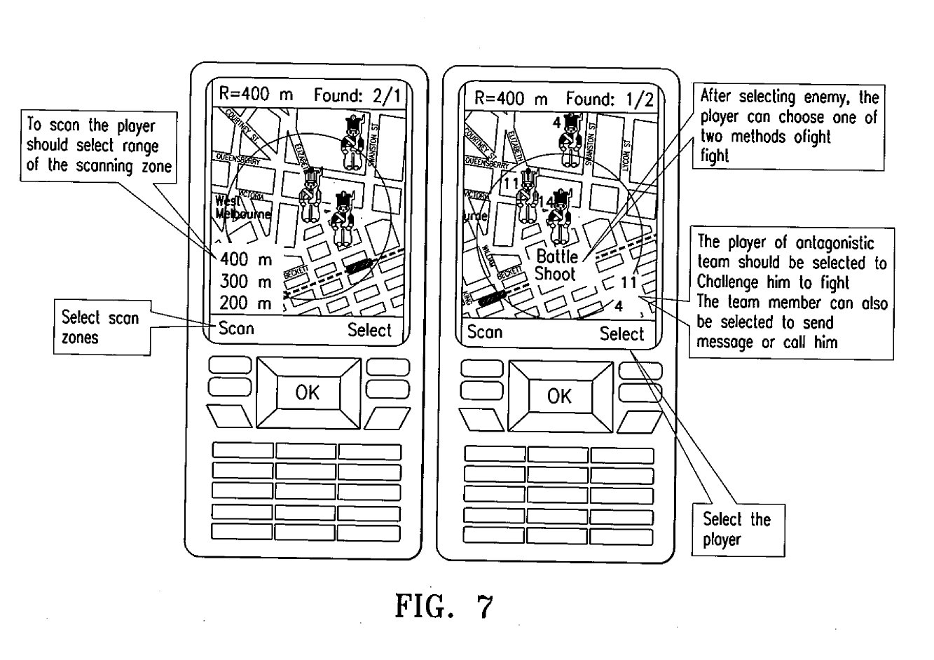

FIG. 7 shows a representative view of the game in which a player is given the choice to select the physical range to scan for enemies or foes (left figure) and a particular player to interact with (right figure).

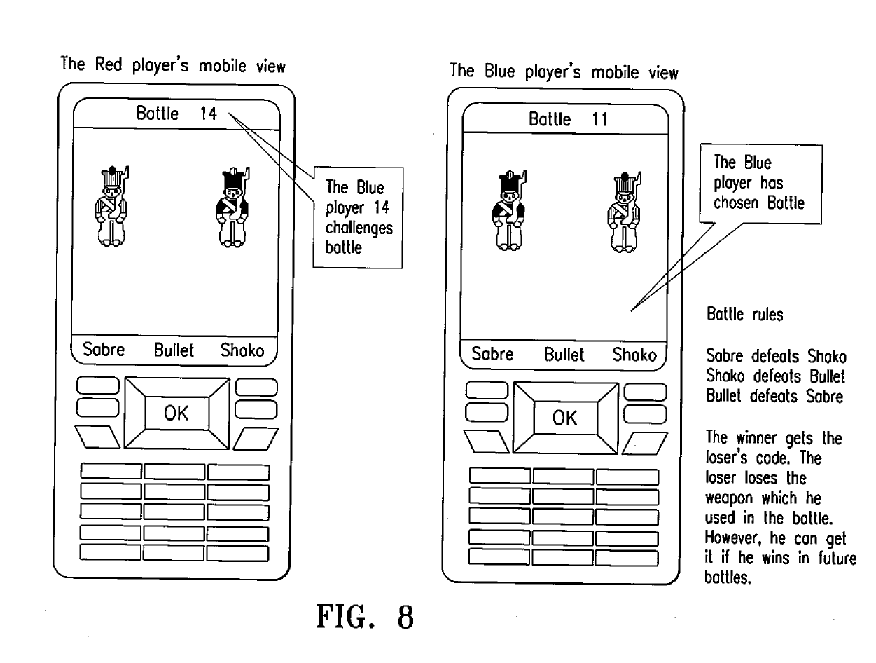

FIG. 8 shows a representative view of the game when two players enter into a battle. In one embodiment, the rules of the battle is that the winner acquires the loser's weapon used in the battle and token(s) without taking the loser's life. Therefore, the loser can continue to play in the game and win back his weapon and token(s) in future battles. In battle mode, the real-time locations of the players are not required and the players can play in “stationary mode”.

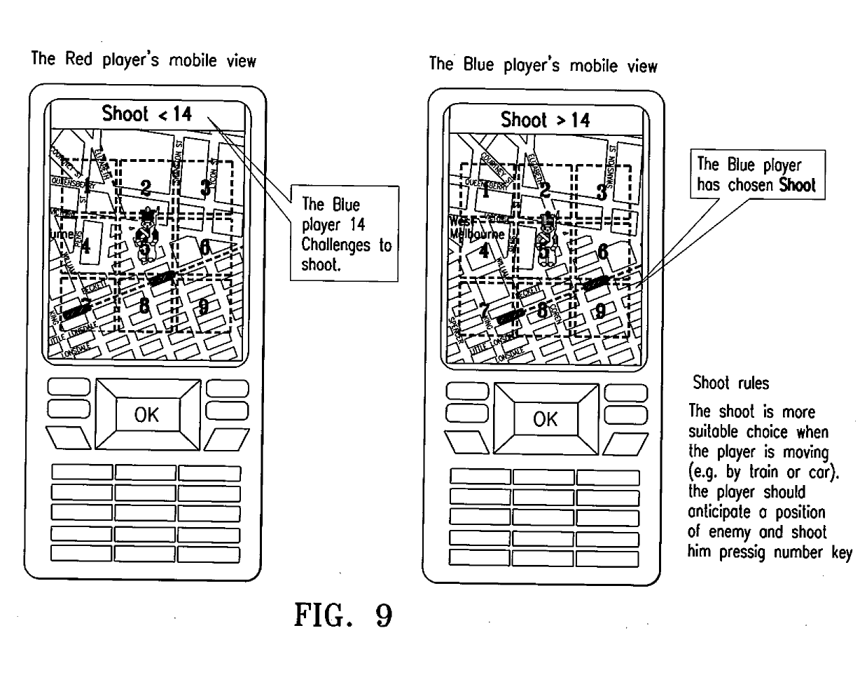

FIG. 9 shows a representative view of the game when two players enter into a shoot out. In this mode, the players' real-time movement may be incorporated into game play. For example, as shown in the figures, at the beginning of the shoot out, the position of the players are placed at the center of a positional grid. Each player then selects a grid cell to shoot by pushing a corresponding number in the keypad. If the opposing player's real-time movement places his/her game character in the selected cell, the character is shot. In one embodiment, the rules of a shoot out is such that the player is eliminated from the game when the character is shot. In other embodiments, the shot player may simply be injured and given a chance to escape.

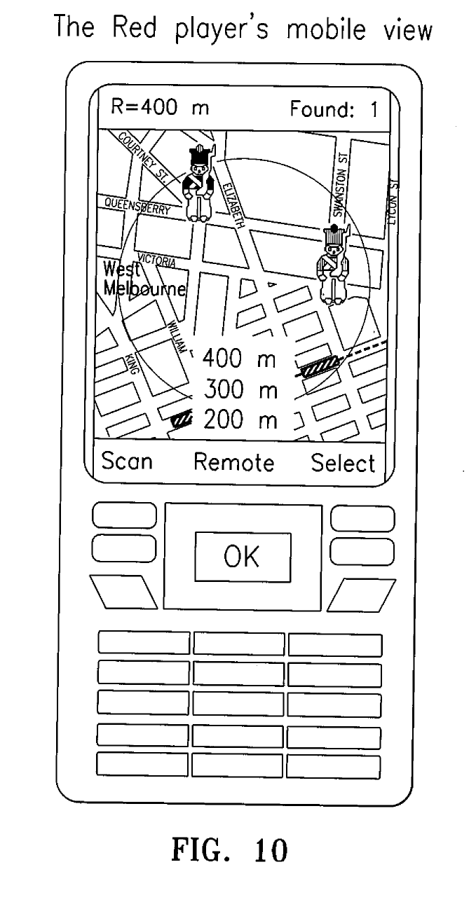

FIG. 10 shows a representative mobile view of the game. In this view, the player has an ability (bonus) to scan remotely. He can select any place on the map (or choose from a location list) to scan via LBS. The bonus could be of single use. The player may get additional bonus when he sends a predetermined number of captured codes or purchases additional bonuses from a vendor. By having the ability to scan remotely, the player gains additional information about the current state of the game. The player can select an opponent to fight or send a message/talk to inform the team members to gang up on an opponent. The player can send the captured token to the team member which already has one and sends both tokens to the system. Both team members earn bonuses and share points in high score list. Because it is easier to win by pair work, this “remote scan” option gives a player a winning tactical advantage over the opponents. The winning tactical advantage is preferably an unfair advantage. Given that garners are willing to pay for “cheats”, this option will encourage additional use of LBS, thereby, further enhances the revenue for LBS.

Numerous combinations of team organization are possible. Although it is preferred that players can join a game at any time, in one embodiment, players may elect to wait for a full team to be formed (e.g., 20-20 gamers) before starting the game. The players can go out of the game (for different reasons) and another player from the waiting line may then take the exiting player's place in the game. If a player has accumulated certain scoring status or tokens, the player may choose to sell his position to another player.

In another embodiment the players can join the game immediately and compete with game characters controlled by artificial intelligence algorithms, also known as AI agents or bots, generated by the game system. The players enter to the antagonistic teams alternatively replacing the bots in each team.

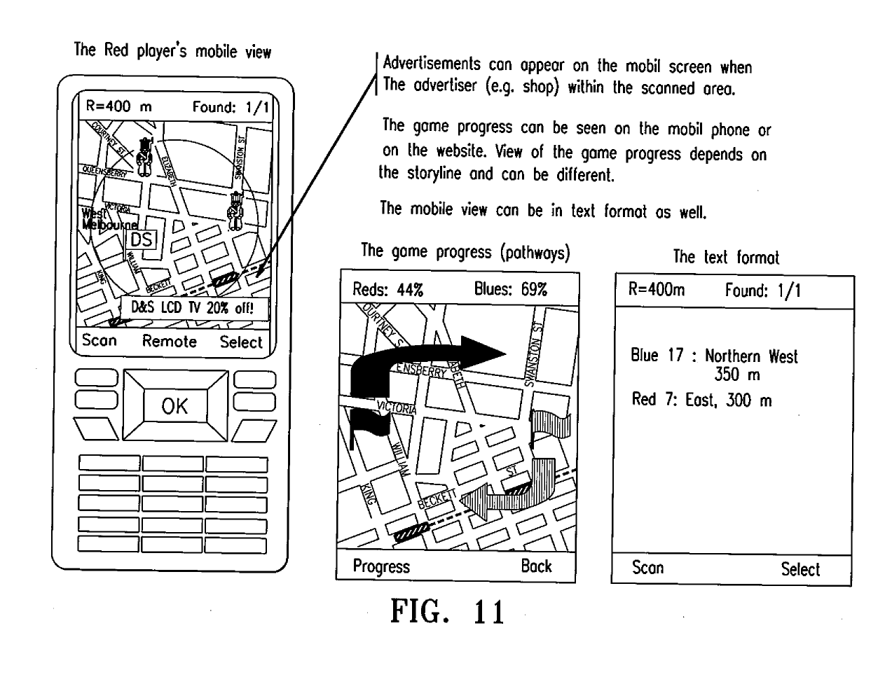

These different formats of team organization may further provide a revenue source for the LBS carriers. For example, LBS carriers may offer partnership opportunities for stores, shopping malls, cafes, schools, or the like. FIG. 11 shows a representative view of the game where advertisement may be fed to the game. In one embodiment, stores may sell virtual ammunitions for the game. A player who has run out of ammunition may choose to locate a store nearby to buy virtual ammunition or seek shelter from the pursuing opponent. Depending on the specific storyline of the game, other merchandizing and partnership opportunities may also be offered.

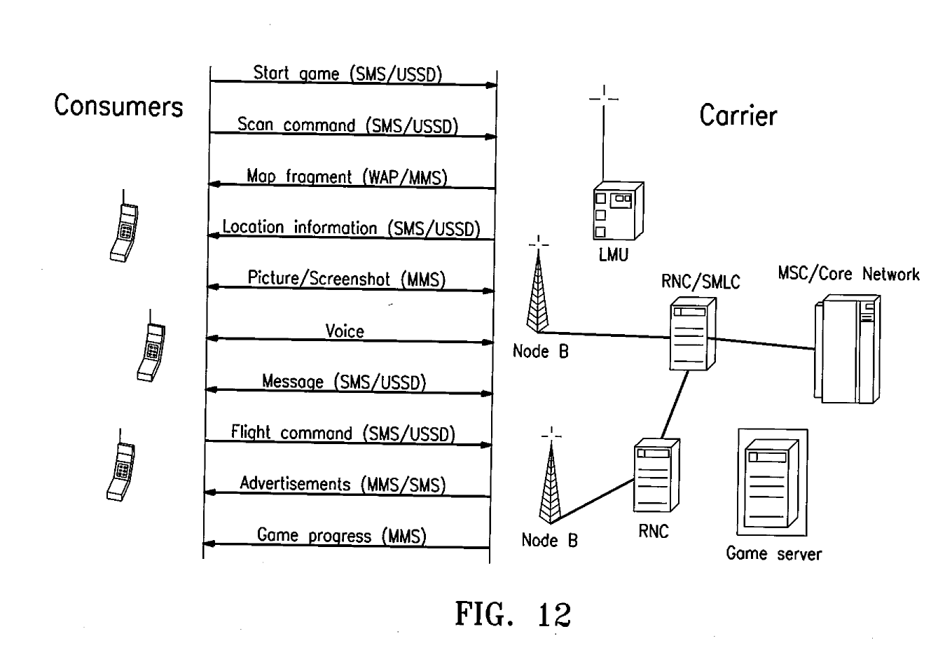

The players may use a spectrum of the mobile carrier's services such as SMS/MMS/USSD/voice. FIG. 12 shows a representative selection of services available on a typical carrier. The messages and calls made in the game are considered separately from the services made out of the game in order to calculate the game profit contribution. Each game message/call includes a marker that allows determining the message origin.

### 3. Customers

Unlike other specialized LBS applications in which the customer base is limited to a population with special needs (e.g. trucking companies, taxi fleets, etc.) the customer base for LBG of the present invention can literally be anyone on the planet with access to the network infrastructure. For example, students, co-workers, family members, etc. The choice of target customer is preferably compatible with the content of the LBG, and vice versa.

### 4. Finances

Referring again to FIG. 2, in a business model of the present invention, the stake holders of both the gaming industry and the telecommunication carriers are merged into a single value chain. Therefore, the revenues of the LBS is tightly linked to the adoption of the game. In this respect, the LBS revenue generated from the game for a carrier may be expressed as:

ARPU=X_{LBS}×T_{LBS}×M

where ARPU is Average Revenue Per User, X_{LBS} is the average number of LBS event triggered by a user during a game, T_{LBS} is the average duration per LBS event, and M is the fee charge per unit time of LBS usage. The total revenue due to a game, then, can be expressed by the formula:

R=ARPU×U

where R is the total revenue, and U is the total number of players.

Given the above formula, one can see that in order to increase the total revenue R, one must either increase U or ARPU or both. Because games of the present invention may be offered for free and may be playable by anyone, the potential market is essentially the entire population, including existing network subscribers and non subscribers who may sign on just to play the game. Compare to other non-game applications where there is an inherent limit to the number of users (e.g. trucking companies or taxi fleets), the potential increase in U is substantially greater. Compare to existing games in which the game format places certain restrictions on the potential players (e.g. educational games may only be of interest to students, seek and destroy games may only appeal to those who have dedicated free time to play the game) the potential size of players in a game in accordance with the present invention is also much greater since no particular limitations are placed on players.

As for the potential to increase ARPU, the value of M may substantially be the same among different vendors, therefore, the key is in increasing the number of LBS event that may be initiated by the players. In games such as botfighter, although the duration of LBS may be larger because constant LBS communication must be made to maintain the game, the charge is presented to the players as the basic cost to enter the game, hence, most casual garners are unlikely to assume such expense just to pass time. However, in games of the present invention, maintenance of constant LBS communication is not required. Therefore, the cost to participate is much smaller, which, in turn, greatly expands the number of players. But more importantly, because triggering of LBS events gives the players a winning advantage over the opponents (preferably an unfair advantage), there is an inherent psychological reward for the players to trigger LBS events. Furthermore, because game play does not require dedicated block of time, players can play any time, any where. As a result, the cumulative duration of LBS usage can be expected to greatly increase.

Additional revenue may be received by the carrier from any advertisements relayed to consumers via the mobile devices when the user is in the area where advertised product is located. Because games will allow players to opt-in for in-game advertisement, this revenue source is not precluded by the CAN-SPAM Act. Shopping centers that have large numbers of shops and brands competing for player's attention would not interfere with the player's current activity since they would physically be in such a location already. Moreover, the advertisement may be woven into the game play so as to even become desired by the players.

To further incentivize the players, the LBG may provide players with real-world rewards such as unique specials or prizes. Such real rewards may make playing the game far more attractive to the mass market and can be provided by the operators and/or advertisers.

Although the present invention has been described in terms of specific exemplary embodiments and examples, it will be appreciated that the embodiments disclosed herein are for illustrative purposes only and various modifications and alterations might be made by those skilled in the art without departing from the spirit and scope of the invention. The scope of the invention is, therefore, indicated by the appended claims rather than by the foregoing description. All changes which come within the meaning and range of the equivalence of the claims are to be embraced within their scope.

What is claimed is:

1. A business method for generating a revenue from location-based telecommunication services, comprising:
(1) providing a telecommunication infrastructure offering telecommunication services, including location-based services;
(2) providing a location-based game capable of utilizing all telecommunication services provided by the telecommunication infrastructure, including location-based services, wherein the game supports a stationary mode, a mobile mode, and combinations thereof; and
(3) accounting for usage of the location-based services by at least one player during game play,
wherein the game is designed such that usage of location-based service provides game winning advantages to the players, thereby encouraging the usage of the service.

2. The business method of claim 1, wherein the location-based game is a team-oriented game.

3. The business method of claim 1, wherein the location-based game is hosted on a game server in communication with the players via the telecommunication infrastructure.

4. The business method of claim 1, wherein the location-based game maps a virtual space in the game to a physical space in a scalable zone fashion and wherein the player is allowed to choose any scalable zone supported by the game.

5. The business method of claim 4, wherein the player is allowed to choose a scalable zone not corresponding to the zone that maps to the physical space in which the player currently resides.

6. The business method of claim 1, wherein the game further includes artificial intelligence algorithm controlled opponents.

7. The business method of claim 1, wherein the telecommunication infrastructure comprises a communication network and a plurality of mobile terminals capable of sending and receiving messages via the network, executing software programs, accepting inputs from users and displaying outputs to the users, and wherein the step of providing a location-based game is performed by allowing the player to download the game from a server, pre-installing the game on the mobile terminal, or combinations thereof.

8. The business method of claim 1, wherein the location-based game is provided to the player free of charge.

9. The business method of claim 1, wherein the location-based game offers a prize for winner of the game.

10. The business method of claim 1, wherein the location-based game is based on a storyline.

11. The business method of claim 1, wherein the location-based game is a role-playing game.

12. The business method of claim 1, wherein the location-based game has a game logic according to the algorithm shown in FIG. 5.

13. The business method of claim 1, wherein the step of accounting for usage of location-based service further comprises charging a fee to the player according to the usage.

14. The business method of claim 1, wherein usage of the location-based services during the game is pre-paid.

15. The business method of claim 1, wherein usage of the location-based service is charged on a subscription-basis.

16. The business method of claim 1, wherein the location-based game is implemented using preexisting telecommunication infrastructure and telecommunication equipment, including mobile terminals.

17. A method of administering a location-based game hosted on a game server over a telecommunication network, comprising:
(1) creating a virtual space having a plurality of zones within the game, wherein the plurality of zones are mapped to regions of physical space covered by the telecommunication network;
(2) allowing players to join the game by establishing communication with the game server via the telecommunication network, wherein upon joining, each player is assigned a token;
(3) providing the players with information of game environments upon request by the players, wherein the game environment for each player is determined by the physical location of the player, and wherein said request by the players is performed by utilizing location-based services provided on the telecommunication network;
(4) allowing the players to choose a virtual zone to explore, wherein the act of exploring includes scanning for other players currently residing in the chosen zone; and
(5) allowing the players residing within the chosen zone to interact with each other in a competitive contest, wherein upon winning the contest, the winning player receives the token(s) of the losing player,
wherein the game is completed when a player or a team of players accumulates a predetermined number of tokens to win the game.

18. The method of claim 17, wherein the game server further comprises a game website server hosting game-related web applications.

19. The method of claim 17, wherein a player can join the game while the game is already in progress or at the beginning of the game.

20. The method of claim 17, wherein the game is a team-oriented game and wherein when a player joins the game, the player is given a choice to choose a team affiliation or assigned to a team by the game.

21. The method of claim 17, wherein communication between the player and the game server is done via a location-based services (LBS) enabled mobile terminal.

22. The method of claim 17, wherein the game supports a mobile mode, a stationary mode, and their combinations.

23. The method of claim 17, wherein the game is capable of utilizing all services offered by the telecommunication network.

24. The method. of claim 17, wherein said competitive contest is one selected from virtual fighting, shooting, a game of chance, or contest of wits.

25. The method of claim 17, wherein the act of joining a game further comprises downloading a copy of the game over the telecommunication network.

26. The method of claim 17, wherein the token assigned to each player represents a piece of global token required to complete the game, wherein the game is completed when a player or a team of players accumulates all pieces necessary to obtain the global token.

27. A mobile terminal configured with a location-based game according to claim 17.

28. A process for designing location-based games suitable for deployment on a telecommunication infrastructure offering telecommunication services including location-based services, comprising:
performing a value-chain analysis to build a value-chain model that describes a value creation process having a plurality of value creation activities, wherein the value-chain activities encompasses activities from both the game industry and the telecommunication industry;
identifying a value creation activity of interest from the telecommunication industry; and
creating a design for the game utilizing the value creation activity of interest in the game such that the value creation activity of interest is presented in the game as a feature that gives players of the game a winning advantage.
